(19) United States
(12) Patent Application Publication
(10) Pub. No.: US 2009/0272683 A1
(43) Pub. Date: Nov. 5, 2009

(54) Jet Dispenser, Filter Fastening System, Nozzle Fastening System

(75) Inventors: Reinhold Rose, Leverkusen (DE); Olaf Behrend, Koln (DE); Martin Poggel, Frankfurt (DE); Lars Obendorf, Leichlingen (DE)

Correspondence Address: NORRIS, MCLAUGHLIN & MARCUS, 875 THIRD AVE, 18TH FLOOR, NEW YORK, NY, 10022, US

(73) Assignee: BAYER TECHNOLOGY SERVICES GMBH, Leverkusen (DE)

(21) Appl. No.: 12/162,834

(22) PCT Filed: Feb. 12, 2007
(86) PCT No.: PCT/EP07/01166

§ 371 Date: Oct. 10, 2008

(30) Foreign Application Priority Data
Feb. 24, 2006 (DE) 10 2006 008 688

(51) Int. Cl. B01D 29/00; B01D 35/28; B01D 35/00

(52) U.S. Cl. 210/238; 210/445; 210/453

(57) ABSTRACT

The invention relates to a device (1) for the treatment of substance mixtures conveyed under high pressure, with a casing (3) surrounding a high-pressure space (2), with at least one sealing means (12) in order to seal off the high-pressure space (2) with respect to the surroundings, and with an inlet (4) and an outlet (5) in order respectively to supply the substance mixture to be treated to the high-pressure space (2) and to discharge it from the high-pressure space (2). The high-pressure space (2) is closed, via at least one cover for mounting and demounting, by a processing module arranged in the high-pressure space (2), the cover having a central fastening means (6) which can be locked, oriented coaxially with respect to the casing (3).

The present invention relates to a device for the treatment of substance mixtures conveyed under high pressure, with a casing surrounding a high-pressure space, with at least one sealing means in order to seal off the high-pressure space with respect to the surroundings, and with an inlet and an outlet in order respectively to supply the substance mixture to be treated to the high-pressure space and to discharge it from the high-pressure space, the high-pressure space being closed, via at least one cover for mounting and demounting, by a processing module, such as, for example, a nozzle module or filter module, arranged in the high-pressure space.

A device of the abovementioned type is known and is described, for example, in DE 102 24 634 C2. In this device, to fasten and seal off the high-pressure space, eight tension screws are provided at regular angular intervals axially parallel to the central axis of the device and brace the end-phase covers of the device with respect to one another such that they press with a high pressure force against the marginal surfaces of the casing surrounding the high-pressure space. So that a permanently leaktight seal withstanding high pressure loads can be provided between the casing and the covers, a metallic seal is provided in this device. The sealing-off action is achieved by means of a plastic deformation of the metallic sealing elements, which is achieved by bracing the tension screws with a high tightening torque. So that a nozzle or filter change can be carried out or a filter can be cleaned, the multiplicity of screw connections has to be released, this being highly time-consuming and complicated. Furthermore, after demounting and renewed mounting, it is necessary to tighten the screws uniformly on the circumference of the holding arrangement. If the screws are not tightened uniformly, it is possible that the nozzle or filter is pressed down asymmetrically or the cover does not bear completely against the casing. This results in leaks and a higher wear of the sealing surfaces. Furthermore, longer set-up times are to be expected because of the large number of screws.

Owing to the screws distributed axially parallel on the circumference and to the centrally seated nozzle insert, structurally induced steps in the holding arrangement cannot be avoided, and therefore high notch effects may occur during operation. The eccentrically seated screws, moreover, generate a bending moment with respect to the central axis of the device, with the result that the material load, particularly during an often used pulsating type of operation of the device, may lead to material fatigue or to damage in the regions loaded by the forces caused by the bending moment. Furthermore, in this device, the system pressure of up to 1500 bar has to be absorbed solely by the tension screws, thus requiring a correspondingly high tightening torque and a bulky form of construction of the device.

DE 107 00 810 A1 discloses a device for the homogenization of fatty liquid natural products, in which the processing module inserted into the high-pressure space has two or multistage dispersing devices. Here, too, the sealing off or the bracing of the cover and of the casing of the device takes place via corresponding screw connections arranged axially parallel, so that the problems referred to above also arise in the same way in this device.

The object of the present invention, therefore, is to provide a device which allows a simple mounting and demounting of the processing modules, at the same time with a lighter type of construction, and which ensures a reliable operation in the high-pressure range of up to 1600 bar.

This object is achieved, according to the invention, in that the cover has a central fastening means which can be locked, oriented coaxially with respect to the casing.

In other words, the invention is based on the fundamental idea that, by the fastening element being oriented coaxially with respect to the processing module or to the casing, asymmetric loads which may be caused, for example, by unequal tightening torques and by bending moments in the device are avoided, so that a lower material load, even during pulsating pump operation with frequent load changes, is achieved. In the set-up according to the invention, the coaxially arranged fastening element serves solely for positioning the processing modules and/or the sealing elements with respect to one another.

A particularly compact type of construction arises when the fastening means is arranged inside the casing. In this exemplary embodiment, the outlet may be formed in the cover.

In an advantageous embodiment of the invention, the device is of cylindrical design. Regions capable of undergoing a notch effect are thereby avoided, so that the material is exposed to low wear and a low risk of material fatigue and is consequently subject to a lower probability of failure.

In a further embodiment, the fastening means is screwed axially to the casing in such a way that only one pressure-bearing thread is provided, so that lower material load, even during pulsating pump operation with a large number of load changes, is afforded. However, locking of the fastening means in the device by means of latching connections or bolt connections may likewise be envisaged.

In order to secure the fastening means against unintended release from the casing of the device, at least one fastening element, for example a headless pin, may be provided. Here, too, a latching mechanism may be arranged as an alternative between the casing and the fastening means.

So that even processing modules with different connection geometries can be received in the high-pressure space, the invention provides, in a further exemplary embodiment, for the provision, between the fastening means and the processing module, of a free-throughflow adapter piece, the dimensions of which are adapted to the geometry of the processing module. As a result, simply by the adapter piece being exchanged, the device can be used in a versatile way for various processing modules with different connection geometries.

In an advantageous embodiment of the invention, the sealing means is a double radial sealing system, in order to secure the high-pressure space against undesirable fluid outflow. Other sealing systems known in the prior art may likewise be envisaged.

For the exact positioning of the sealing means in the device according to the invention, the fastening means may have at least one cutout on the inlet side. The sealing system can then be positioned such that the surface pressure necessary for sealing off is applied, solely by the system pressure which may amount to 1600 bar, to the sealing means inserted into the cutoff, this being equivalent to a type of self-sealing system.

For the detection of sealing leakages possibly occurring, for example, due to ageing or material fatigue of the sealing elements, in an exemplary embodiment of the present invention there may be provided in the casing a leakage bore, through which substance mixture possibly emerging from the high-pressure space can be led out of the device and thereby made visible and can be discharged in a controlled way.

In an alternative exemplary embodiment, the processing module comprises at least one nozzle body, in particular at least one jet disperser nozzle unit oriented axially in the high-pressure space and/or at least one flow divider unit and/or at least one filter unit for purifying the substance mixture and/or at least one free-throughflow component which can be positioned, in particular, in series connection in the high-pressure space. Owing to the possibility of the flexible compositions of the processing module, the device according to the invention can be used for various processing tasks. Thus, for example, it is possible in a simple way to implement a series connection of jet dispersers and filters in a single component.

If a plurality of units are connected in series one behind the other, it is expedient in each case to separate the units from one another by sealing means. Thus, for example, a sealing means, such as, for example, a double radial sealing system, can be inserted upstream of each flow divider unit on the inlet side.

In an embodiment of the present invention which is particularly preferred in terms of flow and manufacturing aspects, the processing module is also oriented coaxially with respect to the casing or to the fastening means.

With regard to further advantageous refinements and developments of the invention, reference is made to the subclaims and to the following description of an exemplary embodiment, with reference to the accompanying drawings in which:

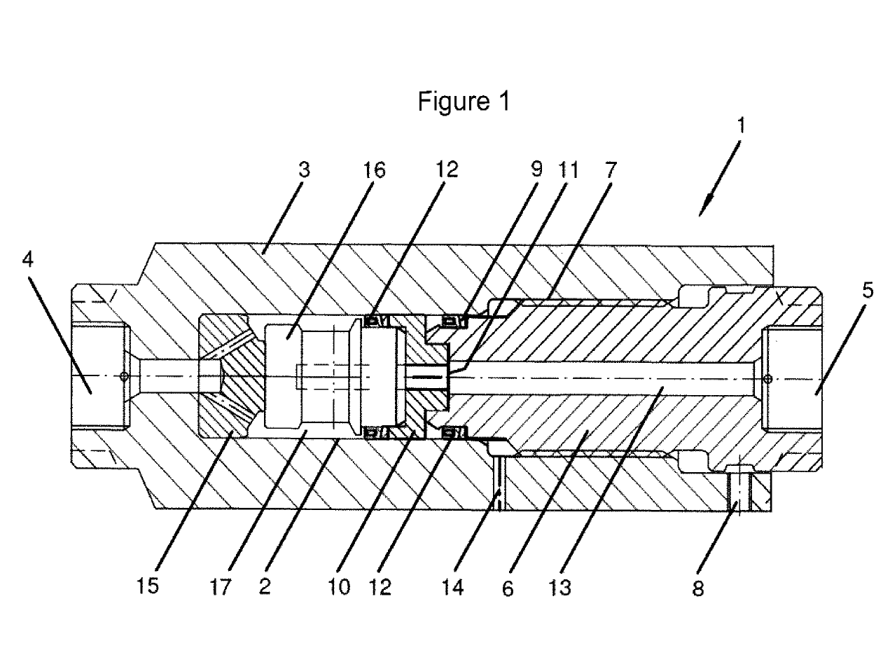

FIG. 1 shows a device for the stressing of substance mixtures by high-pressure expansion, for example for the production of emulsions or for the cellular breakdown of biological systems;

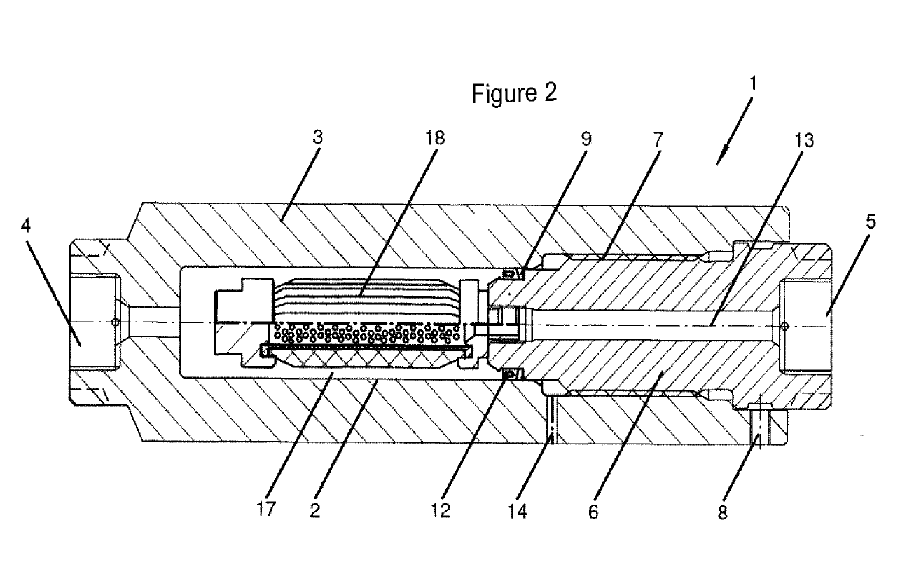

FIG. 2 shows a device with a filter unit for the purification of substance mixtures, in particular for the protection of high-pressure nozzles against blockage;

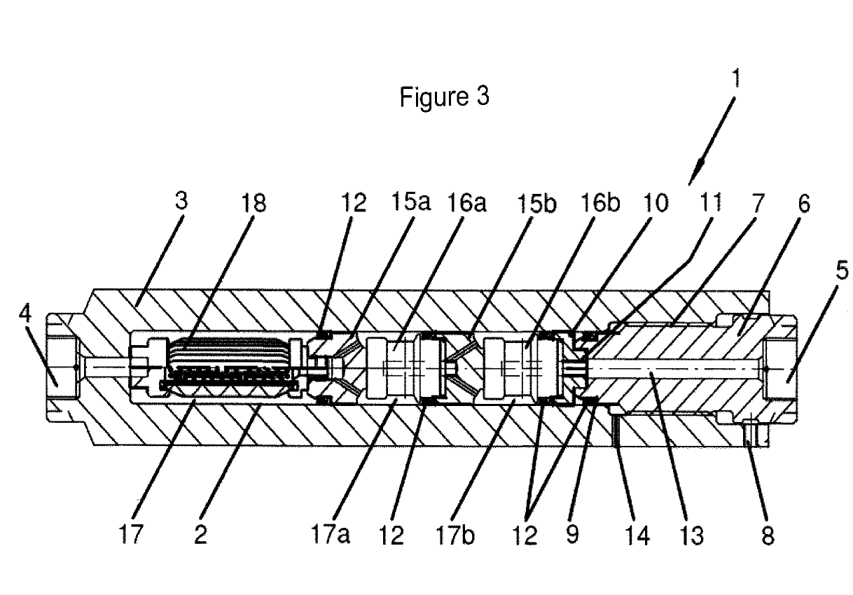

FIG. 3 shows a device with a processing module having an “in-series arrangement” of units for the purification and high-pressure expansion of substance mixtures.

FIG. 1 shows a device 1 for the treatment of substance mixtures conveyed under high pressure, with a casing 3 surrounding a high-pressure space 2. The device 1 has in each case on the end faces an inlet 4 and an outlet 5 in order respectively to supply the substance mixture to be treated to the high-pressure space 2 and to discharge it from the high-pressure space 2. A fastening means 6 is designed cylindrically and has an external thread 7, via which the fastening means 6 is screwed on the outlet side to an internal thread of the casing 3. The inlet 4 and the outlet 5 are designed such that they can be inserted into a suitable high-pressure screw connection, not illustrated, and can thus be connected to a processing circuit. To secure the fastening means 6 in the casing 3, the casing 3 has a clearance 8, into which a fastening element, for example in the form of a headless pin, not illustrated, is inserted. An adapter piece 10 is inserted on the inlet side into a depression 11 of the fastening means 6. The high-pressure space 2 is sealed off via a sealing means 12 which is arranged upstream of the adapter piece 10 in the flow direction. In this exemplary embodiment, a further seal 12 seals off against fluid outflow the flow-off space 13 which is likewise under high pressure, depending on the installation conditions.

In the region of the flow-off space, a leakage bore 14 is provided in the casing, so that sealing leakages can be detected quickly and simply. In this exemplary embodiment, a processing module is composed of a flow divider 15 and of a nozzle body 16.

To treat the substance mixture, the latter flows under high pressure via the inlet 4, with a negligible pressure loss, through the flow divider 15 into the outside space 17 which surrounds the nozzle body 16. The substance mixture subsequently flows through nozzle bores, not illustrated in the drawing, in the nozzle body 16, with the result that an expansion of the substance mixture is achieved. The substance mixture is discharged via the inside space, likewise not illustrated, of the nozzle body 16 and the bores through the adapter piece 10 into the outlet 5 integrated in the fastening means 6.

FIG. 2 shows a device 1 for the purification of substance mixtures, in particular in order to protect high-pressure nozzles against contamination and clogging. The basic set-up of the device 1 according to FIG. 2 is identical to that of the device 1 according to FIG. 1. Identical components are therefore given the same reference numerals. The difference is merely in the composition of the processing module in the high-pressure space 2. Here, instead of the flow divider 15, the nozzle body 16 and the adapter piece 10, only a filter unit 18 is provided for the filtration and purification of the substance mixture of dirt particles possibly contained in the substance mixture.

Here, too, the substance mixture flows under high pressure through the inlet 4 into the outside space 17 of the filter element 18. During the flow through the filter element 18, only a slight pressure drop can likewise be detected in the substance mixture.

If, by means of the device 1 according to the invention, for example, a single-stage or multistage breakdown of biological cells is to be implemented via nozzle body units connected in series, the inflowing substance stream does not necessarily have to be filtered. In this case, the filter 18 may be removed from the device 1 and the position of the filter 18 filled, for example, by a free-throughflow component.

FIG. 3 shows a device 1 for the purification and high-pressure expansion of substance mixtures, with a processing module, the units of which are arranged in an in-series connection.

The substance stream, for example a fluid, flows under high pressure through the inlet 4 into the outside space 17 around the filter element 18, only a slight pressure drop being observable during the flow through the filter element 18. The fluid subsequently flows through the flow divider 15a into the outside space 17a around the first nozzle body 16a. Expansion occurs during the flow through the nozzle bores, not illustrated, introduced in this body 16a. The fluid is subsequently discharged through the inside space of the nozzle body 16a and is conveyed onward through a further flow divider 15b into the outside space 17b of the next nozzle body 16b and subsequently conveyed onward via the inside space, not illustrated, of this nozzle body 16b into the outlet 5 arranged in the fastening means 6. The multistage high-pressure expansion taking place due to the multiple arrangement of the nozzle bodies 16a and 16b serves, for example, for the production of emulsions or may be used for a single-stage or multistage cellular breakdown of biological systems. In cellular breakdown, however, it may in some cases be necessary, depending on the consistency of the biomass, to insert, instead of the filter, into the high-pressure space 2 a free-throughflow component which has the same dimensions as the substituted filter unit.

In each exemplary embodiment, in each case a sealing means 12 in the form of a double radial sealing system is provided at the flow dividers 15a and 15b between the individual nozzle bodies 16a and 16b, so that each individual stage forms in itself a sealed-off closed system and undesirable short-circuit flows of the substance mixture occurring due to the bypassing of a processing module can thus be prevented.

By virtue of the cylinder-like design of the device 1 or of the fastening means 6 and of the casing 3 and by virtue of the central arrangement of the fastening means 6 in the casing 3, on the one hand, regions susceptible to a notch effect are avoided, so that the material is exposed to low wear and is therefore subject to a lower probability of failure. On the other hand, a virtually self-sealing device can be achieved by the radial sealing system being arranged in the flow direction of the substance mixture.

The radial sealing system is arranged such that the centrally seated fastening means does not have to generate the necessary surface pressure of the sealing means for sealing off, but, instead, the system pressure itself generates the necessary surface pressure, so that operation with a system pressure of up to 1600 bar is possible. The fastening means thus serves merely for positioning the sealing surfaces or the various units of the processing module with respect to one another. Since no end-face sealing systems are used, it is also not necessary to generate a corresponding prestress of the fastening means by a correspondingly firm tightening of the screw connections.

1-13. (canceled)

14. A device for the treatment of substance mixtures conveyed under high pressure, comprising
a casing (3) surrounding a high-pressure space (2),
a high pressure space (2);
at least one sealing means (12) associated with the high pressure space for sealing off the high-pressure space (2);
an inlet (4) and an outlet (5) for supplying the substance mixture to be treated to the high-pressure space (2) and to discharge the substance from the high-pressure space (2),
wherein the high-pressure space (2) comprises at least one cover for mounting and demounting, suitable for closing, by a processing module arranged in the high-pressure space (2), and
wherein the cover has a central fastening means (6) capable of being locked, and oriented coaxially with respect to the casing (3).

15. The device as claimed in claim 14, wherein the fastening means (6) is arranged inside the casing (3).

16. The device as claimed in claim 14, wherein the casing (3) is designed cylindrically.

17. The device as claimed in claim 14, wherein the fastening means (6) is screwed axially to the casing (3).

18. The device as claimed in claim 14, wherein the outlet (5) is formed in the cover.

19. The device as claimed in claim 14, wherein at least one fastening element is provided for securing the fastening means (6) against unintended release from the casing (3).

20. The device as claimed in claim 14, wherein the fastening means (6) has at least one depression (11), into which an adapter piece (10) for receiving the processing module can be inserted.

21. The device as claimed in claim 14, wherein the device has at least one sealing means (12) for securing the high-pressure space (2) against undesirable outflow of the substance mixture to be treated.

22. The device as claimed in claim 14, wherein the fastening means (6) has at least one cutout (9), into which the sealing means (12) can be inserted.

23. The device as claimed in claim 14, wherein the sealing means (12) is arranged in such a way that a surface pressure necessary for the sealing action of the sealing means (12) is capable of being applied to the sealing means (12) by the system pressure of the substance mixture.

24. The device as claimed in claim 14, wherein a leakage bore (14) is provided in the casing (3) for the detection of sealing leakages.

25. The device as claimed in claim 14, wherein the processing module comprises at least one nozzle body unit (16, 16a, 16b), and/or at least one flow divider unit (15, 15a, 15b) and/or at least one filter element unit (18) for purifying the substance mixture and/or at least one free-throughflow component which is capable of being positioned in the high-pressure space (2).

26. The device as claimed in claim 14, wherein the processing module is oriented coaxially with respect to the casing (3).

27. The device as claimed in claim 16, wherein the fastening means (6) is designed cylindrically.

28. The device as claimed in claim 19, wherein the at least one fastening element is a headless pin.

29. The device as claimed in claim 21, wherein the at least one sealing means (12) is a double radial sealing system.

30. The device as claimed in claim 25, wherein the at least one nozzle body unit (16, 16a, 16b) is a jet disperser nozzle unit oriented axially in the high-pressure space

31. The device as claimed in claim 14, wherein the at least one free-throughflow component which is capable of being positioned, is a in series connection in the high-pressure space (2).
